(19) United States
(12) Patent Application Publication
(10) Pub. No.: US 2026/0332032 A1
(43) Pub. Date: Oct. 22, 2026

(54) SYSTEMS AND METHODS FOR CONTROLLING A TRANSISTOR FOR A POWER CONVERTER FOR AN ELECTRIC VEHICLE

(71) Applicant: BorgWarner Inc., Auburn Hills, MI (US)

(72) Inventors: James WALTERS, Carmel, IN (US); Eugene RIPLEY, Russiaville, IN (US)

(73) Assignee: BorgWarner Inc., Auburn Hills, MI (US)

(21) Appl. No.: 19/184,897

(22) Filed: Apr. 21, 2025

(51) Int. Cl. H02M 1/08; B60L 15/00; H02M 7/5387

(52) U.S. Cl. CPC H02M 1/08; B60L 15/007; H02M 7/53871

(57) ABSTRACT

A method comprising: determining a control method, among each of a fixed strength (FS) method, a root mean square current (RMS) method, and an instantaneous current (IC) method, for a switch driver of a power converter, based on a switching frequency, a time module lockout time, and a switch driver lockout time; and generating a control signal for the switch driver based on the determined control method.

### TECHNICAL FIELD

Various embodiments of the present disclosure relate generally to controlling a switch driver, and, more particularly, to dynamically determining a gate strength for a switch driver using predicted currents for one or more switching events in a pulse width modulation (PWM) period.

### BACKGROUND

The gate strength of a switch driver (e.g., a gate driver for a transistor) may determine the switch driver's ability to control the switching action of one or more switches. Current gate strengths are chosen not only for switching speed but also to ensure safe operation across a temperature, a DC voltage, and an AC current range of the application. Accommodating these various conditions may restrict the gate strength to a suboptimal value, resulting in excessive switching loss. More specifically, the majority of operating time during typical drive cycles may be performed with too weak of a gate strength resulting in a slower turn on/off event with lower efficiency and higher losses.

The present disclosure is directed to overcoming one or more of these above-referenced challenges.

### SUMMARY OF THE DISCLOSURE

In some aspects, the techniques described herein relate to a method including: determining a control method, among each of a fixed strength (FS) method, a root mean square current (RMS) method, and an instantaneous current (IC) method, for a switch driver of a power converter, based on a switching frequency, a time module lockout time, and a switch driver lockout time; and generating a control signal for the switch driver based on the determined control method.

In some aspects, the techniques described herein relate to a method, wherein the determining the control method includes determining the control method as the FS method based on a first timing requirement.

In some aspects, the techniques described herein relate to a method, wherein the determining the control method includes determining the control method as the RMS method based on a second timing requirement, wherein the second timing requirement is greater than the first timing requirement.

In some aspects, the techniques described herein relate to a method, wherein the determining the control method includes determining the control method as the IC method based on a third timing requirement, wherein the second timing requirement is greater than the first timing requirement, and wherein the third timing requirement is greater than the second timing requirement and the first timing requirement.

In some aspects, the techniques described herein relate to a method, wherein the FS method includes: generating a gate strength based on a peak current and a DC-link voltage to control a first phase, a second phase, and a third phase of the power converter.

In some aspects, the techniques described herein relate to a method, wherein the RMS method includes: generating a gate strength for the switch driver of the power converter based on an RMS current of a phase of the power converter.

In some aspects, the techniques described herein relate to a method, wherein the IC method includes: generating a gate strength for the switch driver of the power converter based on an instantaneous current of a power converter phase; and generating the control signal to control the switch driver based on the gate strength for the switch driver.

In some aspects, the techniques described herein relate to a method, wherein the switch driver is provided in the power converter of an electric vehicle.

In some aspects, the techniques described herein relate to a method including: determining a first switching event for a first pulse width modulation (PWM) period based on an instantaneous current, a voltage, and a position in a PWM sequence; determining a first estimated current based on the first switching event; generating a first estimated gate strength for the first switching event based on the first estimated current; generating an updated gate strength based on the first estimated current; determining a time to modify a switch driver with the updated gate strength; and generating a control signal based on the determined time, wherein the control signal updates a current gate strength of the switch driver with the updated gate strength.

In some aspects, the techniques described herein relate to a method, further including: determining a second switching event for the first PWM period; determining a third switching event and a fourth switching event for a second PWM period; and generating the updated gate strength based on the second switching event, the third switching event, and the fourth switching event.

In some aspects, the techniques described herein relate to a method, wherein determining the updated gate strength includes: determining a second estimated current based on the second switching event; determining a third estimated current based on the third switching event; and determining a fourth estimated current based on the fourth switching event.

In some aspects, the techniques described herein relate to a method, wherein the generating the updated gate strength further includes: generating a second estimated gate strength based on the second estimated current; generating a third estimated gate strength based on the third estimated current; and generating a fourth estimated gate strength based on the fourth estimated current.

In some aspects, the techniques described herein relate to a method, wherein the generating the updated gate strength further includes: generating the updated gate strength based on a weakest gate strength from the first estimated gate strength and the second estimated gate strength.

In some aspects, the techniques described herein relate to a method, wherein the generating the updated gate strength further includes: generating the updated gate strength based on a weakest gate strength from the second estimated gate strength, and the third estimated gate strength.

In some aspects, the techniques described herein relate to a method, wherein the generating the updated gate strength further includes: generating the updated gate strength based on a weakest gate strength from the first estimated gate strength, the second estimated gate strength, and the third estimated gate strength.

In some aspects, the techniques described herein relate to a method, wherein the generating the updated gate strength further includes: generating the updated gate strength based on the second estimated gate strength.

In some aspects, the techniques described herein relate to a method including: determining an RMS current based on a first PWM period; determining a predicted current based on the first PWM period; generating a gate strength based on the RMS current and the predicted current; determining a time to modify the gate strength; and generating a control signal to modify the gate strength of a first phase based on the determined time.

In some aspects, the techniques described herein relate to a method, wherein determining the RMS current based on the first PWM period includes: determining a measured current for a midpoint and an endpoint of the first PWM period.

In some aspects, the techniques described herein relate to a method, wherein determining the predicted current based on the RMS current includes: determining the predicted current based on the midpoint and the endpoint of the first PWM period.

In some aspects, the techniques described herein relate to a method, wherein the generating the gate strength includes: determining a maximum current from the RMS current and the predicted current.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure for a vehicle including a power converter, according to one or more embodiments.

FIG. 2 depicts an exemplary system infrastructure for a power converter, according to one or more embodiments.

FIG. 3 depicts an exemplary system infrastructure for a controller, according to one or more embodiments.

FIG. 4 depicts an exemplary plot of a phase current signal, according to one or more embodiments.

FIG. 5A depicts an exemplary plot of an upper switch gate signal and a lower switch gate signal with a switching event near a middle of a sampling period, according to one or more embodiments.

FIG. 5B depicts an exemplary plot of an upper switch gate signal and a lower switch gate signal with a switching event near a start of a sampling period, according to one or more embodiments.

FIG. 6 depicts an exemplary flow chart of a method for determining a control method for a switch driver, according to one or more embodiments.

FIG. 7 depicts an exemplary flow chart of a method for determining a gate strength using an instantaneous current (IC) method, according to one or more embodiments.

FIG. 8 depicts an exemplary flow chart of a method for determining a gate strength based on a root mean square (RMS) current method, according to one or more embodiments.

### DETAILED DESCRIPTION OF EMBODIMENTS

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of +10% in the stated value. In this disclosure, unless stated otherwise, any numeric value may include a possible variation of +10% in the stated value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. For example, in the context of the disclosure, switching devices may be described as switches or devices, but may refer to any device for controlling the flow of power in an electrical circuit. For example, switches may be metal-oxide-semiconductor field-effect transistors (MOSFETs), bipolar junction transistors (BJTs), insulated-gate bipolar transistors (IGBTs), or relays, for example, or any combination thereof, but are not limited thereto.

Various embodiments of the present disclosure relate generally to controlling a switch driver, and, more particularly, to dynamically determining a gate strength for a switch driver using predicted currents for one or more switching events in a PWM period.

Inverters, such as those used to drive a motor in an electric vehicle, for example, are responsible for converting High Voltage Direct Current (HVDC) into Alternating Current (AC) to drive the motor. A three-phase inverter may include a bridge with six power device switches (for example, power transistors such as IGBT or MOSFET) that are controlled by PWM signals generated by a controller. An inverter may include three half-H bridge switches to control the phase voltage, upper and lower gate drivers to control the switches, a PWM controller, and logic devices between the PWM controller and the gate drivers. The PWM controller may generate signals to define the intended states of the system. The gate drivers may send the signals from the PWM controller to the half-H bridge switches. The half-H bridge switches may drive the phase voltage. Six phase (or other phase) inverters, chargers, DC-DC converters, and/or multi-level inverters are not excluded from this concept and will follow similar principles. The present disclosure refers to an inverter as an example embodiment of a power converter. Power converters may include chargers, inverters, or DC-DC converters, for example.

Electric vehicles, energy storage systems, and backup generators, for example, convert electric power from one form to another. Additionally, an on-board charger for a vehicle, for example, may have a dual purpose. The on-board charger may be a bi-directional system that converts AC voltage to DC voltage in a charging mode (grid-to-battery) and DC voltage to AC voltage in a discharge or inverter mode (battery-to-grid). The charging mode may convert the grid AC into DC voltage to charge the vehicle high voltage (HV) battery, and the discharge or inverter mode may convert the HV battery DC voltage into AC voltage that may be supplied to a load of the grid line voltage, be supplied as a backup generator to power a house when the grid is down, or as an inverter to supply voltage to vehicle AC outlets, for example.

Some solutions may use switch drivers (e.g., gate drivers) with variable gate strength. When employing switch drivers with variable gate strength, the gate strength may be chosen as a function of the average (RMS current) in the load and DC voltage for the entire converter (inverter). Some solutions may attempt to exactly profile the turn on and turn off events of the devices. However, adding this flexibility may result in considerable complexity in finding the optimal profile, as the optimal profile may only be found through testing.

For example, the allowable gate strength may be a function of an inverter's input DC voltage and current through the device. Device temperature may be considered to ensure that worst case scenarios are protected and may be an input to the gate strength selection. Two-pulse testing may be performed to optimize the gate strengths thereby minimizing the inverter's losses in an application. This solution may select the switch driver's turn on and turn off gate strengths based on tables of gate strength versus Vdc and I phase. An example is shown below in Table 1. The values shown in this table represent commands to a switching driver to select the optimal gate strength for the phase current and DC voltage. When two values are shown for an operation point, the first value may be the turn on strength and the second value may be the turn off strength. Lower voltages and currents may be able to use higher gate strengths which reduce the switching loss relative to weaker strengths.

TABLE 1
Gate Strength Matrix

| | |
|---|---|
| Iphase | Vdc-link voltage (V) |

| (pk A) | 650 | 750 | 840 |
|---|---|---|---|
| 50 | Strong | Strong | Medium |
| | (ST) | (ST) | (MD) |
| 100 | Strong | Strong | Medium |
| | (ST) | (ST) | (MD) |
| 150 | Strong | Strong | Medium |
| | (ST) | (ST) | (MD) |
| 200 | Strong | Strong | Medium |
| | (ST) | (ST) | (MD) |
| 250 | Strong | Medium | Weak |
| | (ST) | (MD) | (WK) |
| 300 | Strong | Medium | Weak |
| | (ST) | (MD) | (WK) |
| 350 | Medium | Medium | Weak |
| | (MD) | (MD) | (WK) |
| 400 | Medium | Medium | Weak |
| | (MD) | (MD) | (WK) |
| 450 | Medium | WK + | Weak |
| | (MD) | ST | (WK) |
| 500 | Medium | WK + | Weak |
| | (MD) | ST | (WK) |
| 550 | Medium | WK + | Weak |
| | (MD) | ST | (WK) |
| 600 | Medium | WK + | Weak |
| | (MD) | ST | (WK) |
| 650 | Medium | WK + | Weak |
| | (MD) | ST | (WK) |
| 700 | Medium | WK + | Weak |
| | (MD) | ST | (WK) |
| 750 | Medium | WK + | Weak |
| | (MD) | ST | (WK) |
| 800 | Medium | WK + | Weak |
| | (MD) | ST | (WK) |
| 850 | Medium | WK + | Weak |
| | (MD) | ST | (WK) |
| 900 | Medium | WK + | Weak |
| | (MD) | ST | (WK) |
| 920 | Medium | WK + | Weak |
| | (MD) | ST | (WK) |

Some solutions use a variable gate strength algorithm approach by considering the effective phase current in the inverter (RMS). This solution may provide a single updated gate strength update for all three phases. The updated gate strength may be determined with a DC voltage and the RMS current. This approach may be sub-optimal, however. For example, when the effective current is 282 Arms (400 A peak), Table 1 would assign a weaker strength although the weaker strength may only be required near the maximum and minimum values of the phase current. A higher gate strength may be used for the majority of the waveform when instantaneous current is used when calculating gate strength.

Some solutions may require switch drivers to address specific timing requirements regarding the time between a gate strength change and the next on or off command sent to the device. In addition, there may be requirements on hardware pins when the gate strength is transmitted via discrete output signals. Such cases may include a need for multiple pins to change concurrently.

When employing the RMS approach, where all devices and phases are commanded to use the same strength, setting the gate strength for the actual Vdc and RMS phase current may still need to be performed. In this case, sufficient hysteresis on the current transition points may be provided to ensure that too strong of a gate strength is not used. This hysteresis increases the switching losses due to using a weaker strength.

One or more embodiments may provide for assigning different gate strengths during a waveform. For example, using instantaneous current to determine gate strength may permit using a higher gate strength during a majority of a waveform, and switching to a lower gate strength during times where the waveform may require a lower gate strength. This may result in assigning a higher gate strength during a majority of a waveform thereby improving the efficiency of the device.

One or more embodiments may employ instantaneous current measurements when determining gate strength, thereby allowing for dynamically determining gate strengths. A gate strength may be dynamically determined by using instantaneous current and one or more vector control-based algorithms. The one or more vector control-based algorithms may be machine learning algorithms. Using instantaneous current with one or more vector control-based algorithms may facilitate dynamically determining gate strength for a waveform.

One or more embodiments may reduce inverter loss by using a sophisticated algorithm that considers a PWM technique and switch driver (gate driver) strength timing requirements. For example, rather than using an RMS current from all three phases of a converter (inverter), current from one phase and one or more PWM periods may be used to determine an appropriate gate strength for one or more next switching events for each leg of the inverter. The upper and lower devices in a leg of the converter will see the same current during a switching event.

One or more embodiments may reduce switching loss by predicting the current during a subsequent switching event. For example, the maximum fundamental current frequency in EV and HEV applications may be over 1 kHz. The peak current may not be required at the maximum frequency as is the peak current may be physically unrealizable. However, full current at half maximum frequency may be possible. Using 500 Hz as an example, the di/dt of such currents may be expressed as shown in Equation 1.

$$\frac{di}{dt} = 2 \times π \times 500 \times Iphase \times cos ( 2 \times π \times 500 \times t ) \qquad ( Equation 1 )$$

At a 10 KHz switching rate (100 μsec period) for a 650 Arms (919 A peak) operating point, the maximum change in current in a first period may be 288 A. As shown in Table 1 above, the gate strength may require a change in those cases. Switching events may be many usec removed from the last current sample resulting in the need to predict the current at the sample events to ensure an appropriate gate strength.

One or more embodiments may interleave each phases' current prediction and the corresponding gate strength updates with a PWM strategy to ensure the gates have the correct drive strength during a switching event. A Nearest 2 Vector Space Vector Modulated algorithm (N2V SVM) may be used and other techniques may be used as well (e.g., discontinuous, left aligned, right aligned or inverse-center PWM). In addition, machine learning models such as decision trees, random forest, neural networks, linear regression, artificial neural networks, logical regression, and/or other techniques may be employed to predict current and determine the corresponding gate strength. This approach may switch each device on and off during a switching period (e.g., a PWM period). This period can range from approximately 500 usec to 25 μsec. Due to a switch driver timing requirement, the gate strength may not be commanded by relatively low bandwidth communication pathways such as SPI. Even discrete I/O pins may consider a switch driver's internal timing requirement which may include a lockout window before a switching event. This time may be from approximately 10 usec to approximately 20 usec.

One or more embodiments may dynamically determine a gate strength for one or more PWM periods. For example, on a per phase basis, the upper gate signals and the lower gate signals may be calculated relative to the phase current sample location (0, T, nT). From the on-time values, the time where predicted current is needed may be determined and where the gate strength needs to be updated may be determined. At the start of a PWM calculation window, t=0, phase currents may be sampled and calculations may be made for their control. In some instances, on-times (as switching events) may be calculated for the next PWM update to the devices. Once the on-times for the next period are known, a current at the switching locations may be estimated from a current observer using the last measured current and the commanded voltage. Based on the predicted currents and DC voltage, the appropriate gate strength for each switching event within each PWM period for each phase of a converter may be determined.

One or more embodiments may dynamically determine when to apply (write out) a gate strength, thereby preventing impacting a switching event in the present period. Conceptually, on-time updates to a timer module may be applied just prior to a start of a PWM period or in the middle of a PWM period. Consequently, two distinct cases are apparent. For example, in Case 1, when the next switching event occurs near the middle of the next period (e.g., 1.25 T to 2 T), the gate strength may be written out (applied, commanded, modified) at t=T provided the lockout time of the timer module and the switch driver may be guaranteed. In other instances, in Case 2, if the switching event occurs near the very start of a period (t=T), there may be two options. For cases where the algorithm completes before the gate drive lockout window of the present period's switching event, the gate strength may be updated. This may occur for cases of low switching frequencies. When the switching event occurs before time T and right after time T, the switching event may occur in a lockout window. In such cases, the gate strength update (modification) may need to be determined for the period in the 1.75 T to 2.25 T range. The gate strength update may be applied after the switching event occurring near time T. The update would naturally be made at the time 1.5*T. This may ensure that the gate strength is not changed prematurely thereby impacting a switching event in the present period or the start of the next period.

One or more embodiments may consider updating gate strengths for transitions between Case 1 and 2 and transitions between Case 2 and Case 1. Over a machine fundamental period, especially when needing full voltage, the on-times may range from approximately 0% to approximately 100%. Thus, the transition between Case 1 and 2 may need to be considered. In addition, for duty cycles between Case 1 and 2, there may be potential to update on two edges instead of one, provided that the various lockout times may be satisfied. When the switching frequency becomes too high and the various update times cannot be met, the gate strength update may be pushed to subsequent PWM periods or an RMS-based algorithm can be used.

One or more embodiments may modify to the simplified RMS strategy, thereby addressing the problem of switching loss due to a hysteresis window. Using the one or more embodiments with the simplified RMS strategy (the modified RMS approach) may improve the switching efficiency of one or more devices.

One or more embodiments may determine whether to use a fixed strength (weakest) approach (FS method), a modified RMS approach (RMS method), or an I(t) (IC method) approach to dynamically determine gate strength. Determining whether to use the fixed strength (FS) approach, the RMS current approach, or the I(t) current approach may be based upon switching frequency, timer module lockout time, one or more switch driver IC lockout times, and other time related factors.

One or more embodiments may use an instantaneous current I(t) approach for dynamically determining gate strength. For example, sample currents, positions and Vdc may be determined. One or more vector control-based algorithms may be used to determine voltage and device on-time commands for the next period. On-times for an additional period may be determined and analyzed to determine whether a transition between Case 1 to 2 (or 2 to 1) will occur for any PWM period. Currents may be predicted for each power converter phase (A, B, C) for each switching event in the next two PWM periods. Gate strengths may be determined from Vdc and predicted currents for each switching event of each PWM period for each power converter phase (A, B, C).

One or more embodiments may identify whether the next two PWM edges are located in a Case 1 situation, a Case 2 situation, a Case 1 to a Case 2 transition, or a Case 2 to a Case 1 transition. For Case 1 situations, predicted currents from the next period may be used to determine gate strength. Of these gate strengths, the weaker of the two strengths is selected and commanded at end of PWM period. For Case 2 situations, predicted currents for next period's last switching event and a subsequent period's first switching event may be used to determine a gate strength. However, using only a last period's switching event may be an allowable simplification. The weaker gate strength of the two is selected and commanded in the middle of a PWM period. For Case 1 to Case 2 transitions, predicted currents for the next period's two events and a subsequent period's first event may be used to determine a gate strength. The weakest gate strength of the two may be selected and commanded at the end of a PWM period. For Case 2 to Case 1 transitions, predicted currents for next period's last event may be used to find gate strength. The gate strength may be commanded at end of a PWM period.

One or more embodiments may use a modified Irms (RMS current) approach to dynamically determine a gate strength. Predicted Irms may be determined from a current observer on the measured current for the midpoint and endpoint of a next PWM period. A predicted Icmd may be determined for the midpoint and the endpoint of the next PWM period. A maximum predicted current from the predicted Irms and predicted Icmds may be determined. Gate strengths may be determined for all devices based upon variables Vdc and predicted currents. A determination may be made regarding whether any gate strength change is needed. When determining whether a gate strength change is needed, and determining that switching events occur near the middle of the next PWM period, gate strength updates may be written out at the end of the present PWM period. When switching events occur near the start of the next period, commands may be written out at the end of a present PWM period or the middle of a next PWM period.

One or more embodiments may determine whether the switching rate is a low switching rate. When determining that the switching rate is a low switching rate, sufficient time may be provided to finish all algorithms and update the gate strength by the midpoint of the present period. Update times may be moved to either a present PWM period midpoint or a present PWM period end point.

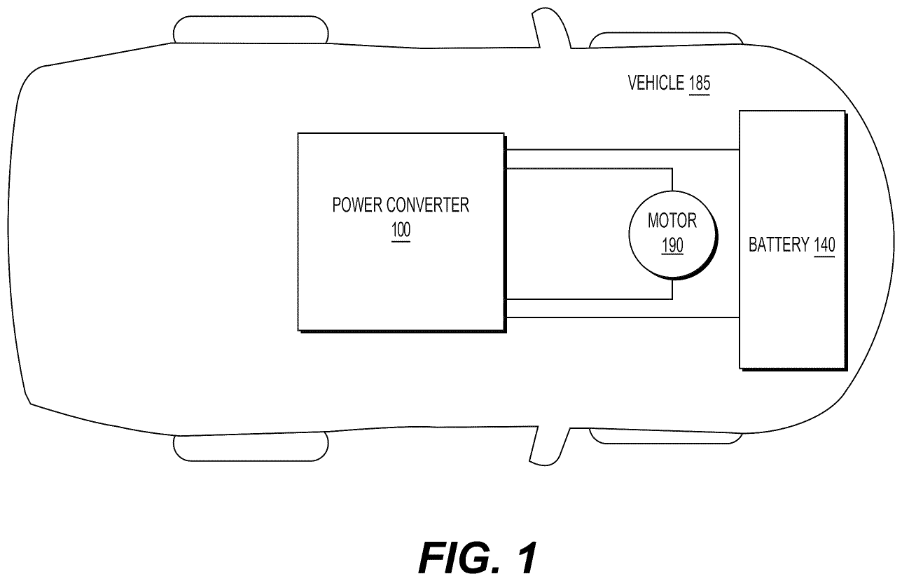

FIG. 1 depicts an exemplary system infrastructure for a vehicle including a power converter, according to one or more embodiments. The power converter 100 may be a combined inverter and converter. Alternatively, the inverter may be an inverter without a converter. In the context of this disclosure, a battery charger, the inverter, the converter, or any combination thereof may be referred to as power converter 100. Electric vehicle 185 may include power converter 100, motor 190, and battery 140. Power converter 100 may include components to receive electrical power from an external source and output electrical power to charge battery 140 of electric vehicle 185. Power converter 100 may convert DC power from battery 140 in electric vehicle 185 to AC power, to drive motor 190 of the electric vehicle 185, for example, but the embodiments are not limited thereto. For example, power converter 100 may include components to receive electrical power from an external source and output electrical power to charge battery 140 without motor 190 connected to power converter 100. Power converter 100 may convert DC power from battery 140 in electric vehicle 185 to AC power, to drive AC components other than motor 190 of the electric vehicle 185. Power converter 100 may be bidirectional, and may convert DC power to AC power, or convert AC power to DC power, such as during regenerative braking, for example. Power converter 100 may be a three-phase inverter, a single-phase inverter, or a multi-phase inverter.

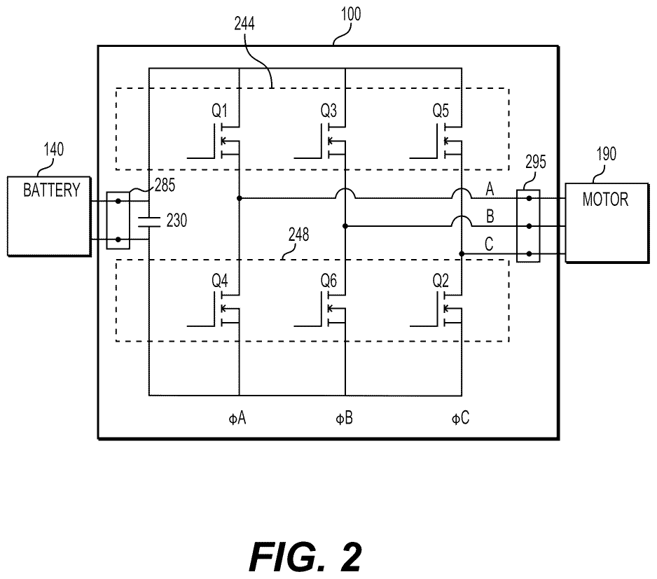

FIG. 2 depicts an exemplary system infrastructure for a power converter, according to one or more embodiments. Power converter 100 may be used to convert DC power from a battery in electric vehicle 185 to AC power, to drive motor 190 of electric vehicle 185, for example, but embodiments are not limited thereto. Additionally, power converter 100 may be bidirectional, and used to convert DC power to AC power, or to convert AC power to DC power.

Power converter 100 may be connected to battery 140 and motor 190.

Power converter 100 may include upper phase switches 244 and lower phase switches 248. A first phase (WA) may include switches Q1 and Q4, a second phase (B) may include switches Q3 and Q6, and a third phase (C) may include switches Q5 and Q2. Upper phase switches 244 may include first phase switch Q1, second phase switch Q3, and third phase switch Q5. Lower phase switches 248 may include first phase switch Q4, second phase switch Q6, and third phase switch Q2. Switches Q1-Q6 may be metal-oxide-semiconductor field-effect transistors (MOSFET), for example, but embodiments are not limited thereto.

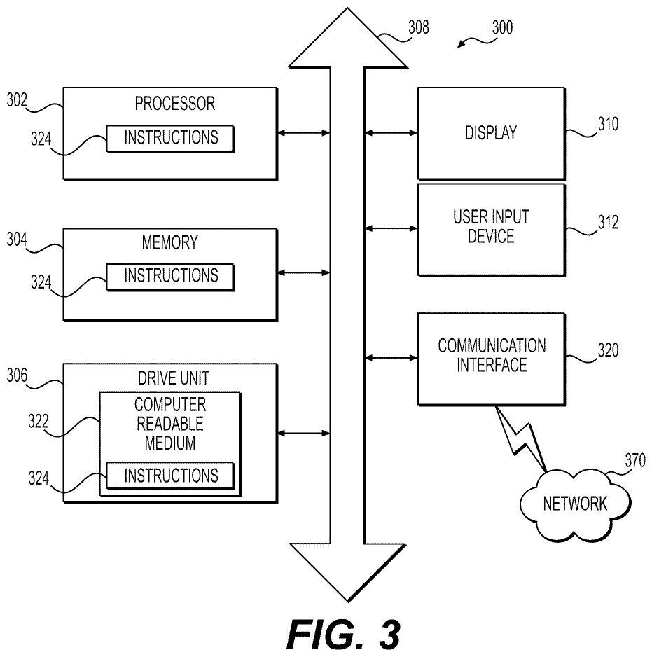

Upper phase switches 244 and lower phase switches 248 may be driven by a PWM signal generated by controller 300 (e.g., see FIG. 3) to convert DC power delivered via the set of input terminals 285 at bulk capacitor 230 to three phase AC power at outputs A, B, and C via the set of output terminals 295 to motor 190. Additionally, although FIG. 2 depicts a three-phase inverter, the disclosure is not limited thereto and may include single phase or multi-phase or multi-level inverters.

FIG. 3 depicts an exemplary system infrastructure for a controller, according to one or more embodiments. Controller 300 may include one or more controllers.

The controller 300 may include a set of instructions that can be executed to cause the controller 300 to perform any one or more of the methods or computer-based functions disclosed herein. The controller 300 may operate as a standalone device or may be connected, e.g., using a network, to other computer systems or peripheral devices.

In a networked deployment, the controller 300 may operate in the capacity of a server or as a client in a server-client user network environment, or as a peer computer system in a peer-to-peer (or distributed) network environment. The controller 300 can also be implemented as or incorporated into various devices, such as a power converter, a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 300 can be implemented using electronic devices that provide voice, video, or data communication. Further, while the controller 300 is illustrated as a single system, the term “system” shall also be taken to include any collection of systems or sub-systems that individually or jointly execute a set, or multiple sets, of instructions to perform one or more computer functions.

As depicted in FIG. 3, the controller 300 may include a processor 302, e.g., a central processing unit (CPU), a graphics processing unit (GPU), or both. The processor 302 may be a component in a variety of systems. The processor 302 may be one or more general processors, digital signal processors, application specific integrated circuits, field programmable gate arrays, servers, networks, digital circuits, analog circuits, combinations thereof, or other now known or later developed devices for analyzing and processing data. The processor 302 may implement a software program, such as code generated manually (i.e., programmed).

The controller 300 may include a memory 304 that can communicate via a bus 308. The memory 304 may be a main memory, a static memory, or a dynamic memory. The memory 304 may include, but is not limited to, computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 304 includes a cache or random-access memory for the processor 302. In alternative implementations, the memory 304 is separate from the processor 302, such as a cache memory of a processor, the system memory, or other memory. The memory 304 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 304 is operable to store instructions executable by the processor 302. The functions, acts or tasks illustrated in the figures or described herein may be performed by the processor 302 executing the instructions stored in the memory 304. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As depicted, the controller 300 may further include a display 310, such as a liquid crystal display (LCD), an organic light emitting diode (OLED), a flat panel display, a solid-state display, a cathode ray tube (CRT), a projector, a printer or other now known or later developed display device for outputting determined information. The display 310 may act as an interface for the user to see the functioning of the processor 302, or specifically as an interface with the software stored in the memory 304 or in the drive unit 306.

Additionally or alternatively, the controller 300 may include an input device 312 configured to allow a user to interact with any of the components of controller 300. The input device 312 may be a number pad, a keyboard, or a cursor control device, such as a mouse, or a joystick, touch screen display, remote control, or any other device operative to interact with the controller 300.

The controller 300 may also or alternatively include drive unit 306 implemented as a disk or optical drive. The drive unit 306 may include a computer-readable medium 322 in which one or more sets of instructions 324, e.g. software, can be embedded. Further, the instructions 324 may embody one or more of the methods or logic as described herein. The instructions 324 may reside completely or partially within the memory 304 and/or within the processor 302 during execution by the controller 300. The memory 304 and the processor 302 also may include computer-readable media as discussed above.

In some systems, a computer-readable medium 322 includes instructions 324 or receives and executes instructions 324 responsive to a propagated signal so that a device connected to a network 370 can communicate voice, video, audio, images, or any other data over the network 370. Further, the instructions 324 may be transmitted or received over the network 370 via a communication port or interface 320, and/or using a bus 308. The communication port or interface 320 may be a part of the processor 302 or may be a separate component. The communication port or interface 320 may be created in software or may be a physical connection in hardware. The communication port or interface 320 may be configured to connect with a network 370, external media, the display 310, or any other components in controller 300, or combinations thereof. The connection with the network 370 may be a physical connection, such as a wired Ethernet connection or may be established wirelessly as discussed below. Likewise, the additional connections with other components of the controller 300 may be physical connections or may be established wirelessly. The network 370 may alternatively be directly connected to a bus 308.

While the computer-readable medium 322 is depicted to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 322 may be non-transitory, and may be tangible.

The computer-readable medium 322 can include a solid-state memory such as a memory card or other package that houses one or more non-volatile read-only memories. The computer-readable medium 322 can be a random-access memory or other volatile re-writable memory. Additionally or alternatively, the computer-readable medium 322 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 300 may be connected to a network 370. The network 370 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to, TCP/IP based networking protocols. The network 370 may include wide area networks (WAN), such as the Internet, local area networks (LAN), campus area networks, metropolitan area networks, a direct connection such as through a Universal Serial Bus (USB) port, or any other networks that may allow for data communication. The network 370 may be configured to couple one computing device to another computing device to enable communication of data between the devices. The network 370 may generally be enabled to employ any form of machine-readable media for communicating information from one device to another. The network 370 may include communication methods by which information may travel between computing devices. The network 370 may be divided into sub-networks. The sub-networks may allow access to all of the other components connected thereto or the sub-networks may restrict access between the components. The network 370 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component or object distributed processing, and parallel processing. Alternatively, virtual computer system processing can be constructed to implement one or more of the methods or functionalities as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the operations of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

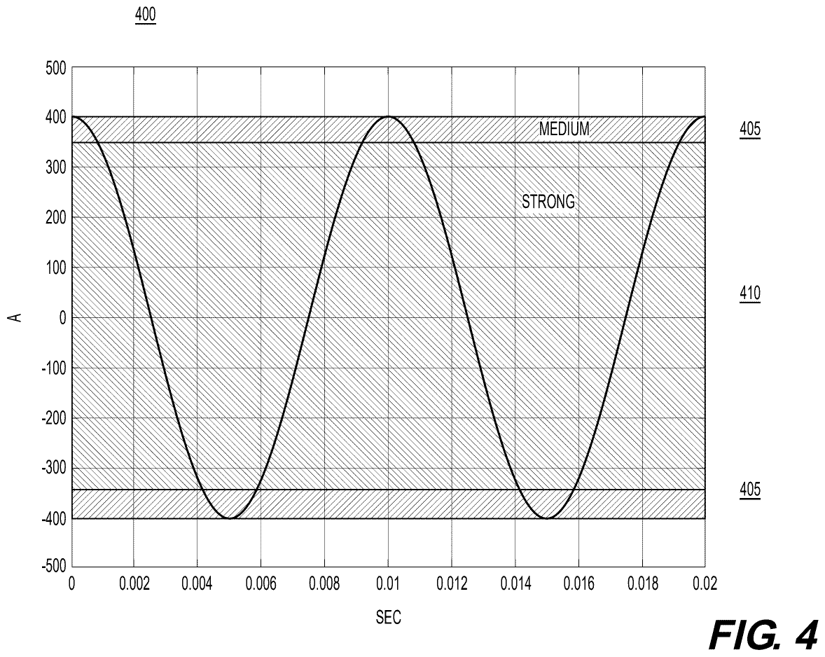

FIG. 4 depicts an exemplary plot 400 of a phase current signal, according to one or more embodiments. As illustrated in FIG. 4, the phase current signal is plotted with respect to time in seconds (x-axis) and current as amplitude (y-axis). Areas 405 of the phase current signal may require a medium gate strength. Area 410 may allow for a strong gate strength.

Some variable gate strength algorithm approaches may consider the effective phase current in the converter (an RMS current) for all three phases for the present DC voltage, as described above. The approach may then select the weakest gate strength for all switch drivers of the inverter for the entire PWM sequence. This approach is sub-optimal, however, as the approach decreases efficiency. For example, the gate strength determination based on the RMS current would calculate a medium strength for the entire phase current signal. On the other hand, employing instantaneous current may allow for employing a medium gate strength during the PWM sequence located in areas 405 and a strong gate strength during the PWM sequence located in area 410.

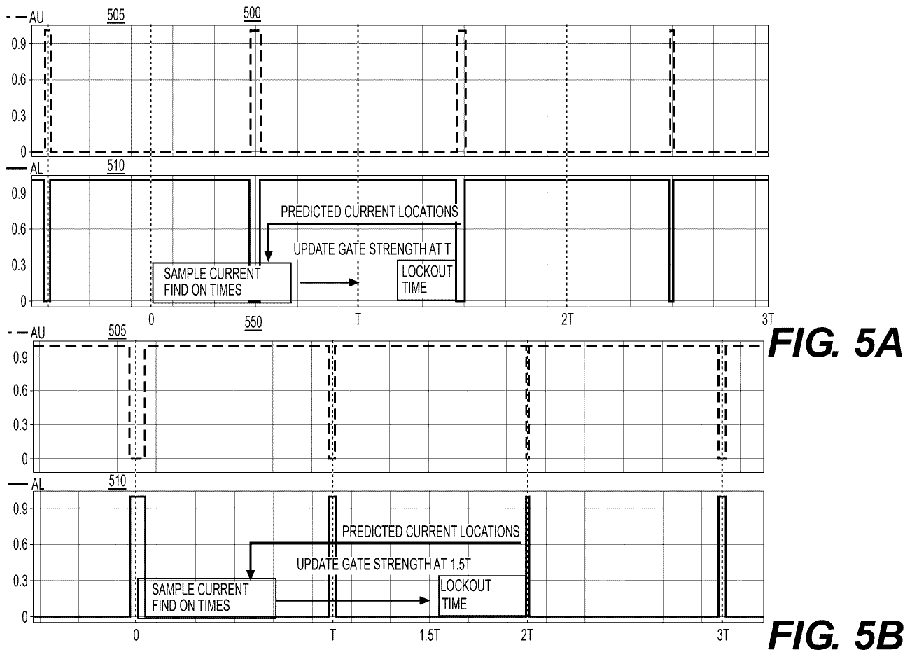

FIG. 5A depicts an exemplary plot 500 of an upper switch gate signal and a lower switch gate signal with a switching event near a middle of a sampling period, according to one or more embodiments. FIG. 5A illustrates upper gate signal 505 and lower gate signal 510. Upper gate signal 505 may be applied to a first switch of a first leg of a converter (e.g., Q1 in FIG. 2). Lower gate signal 510 may be applied to a second switch of the first leg of the converter (e.g., Q4 of FIG. 2). Alternatively, upper gate signal 505 and lower gate signal 510 may be applied to one or more switches. For example, upper gate signal 505 may be applied to one or more of the upper phase switches 244 (Q1, Q3, or Q5) as illustrated in FIG. 2. Lower gate signal 510 may be applied to one or more of the lower phase switches 248 (Q4, Q6, or Q2) as illustrated in FIG. 2.

As described in FIG. 5A, upper gate signal 505 and lower gate signal 510 are shown relative to the current sample location (0, T, nT), on-time calculations, locations where predicted current is needed and where the gate strength needs to be updated. FIG. 5A may depict a Case 1 situation.

Gate strengths may be dynamically determined using instantaneous currents for one or more switching events. At the start of a PWM calculation window, t=0, phase currents may be sampled and calculations may be made for their control. One or more switching events for one or more future PWM periods (e.g., T to 2 T, 2 T to 3 T) may be determined. For example, on-times (the times when an associated switch may be turned on) may be calculated for one or more PWM periods. In some instances, lower gate signal 510 may be determined to turn on (a first on-time) between T and 2 T, a first (next) PWM period. Lower gate signal 510 may be determined to turn on between 2 T and 3 T, a second PWM period. Upper gate signal 505 may have an associated on-times and off-times as illustrated in FIG. 5A.

Once the location of one or more switching events for the next period is known, the current at the switching locations may be estimated from a current observer using the last measured current and the commanded voltage. Based on the predicted currents and DC voltage, the appropriate gate strength for each switching event of each PWM period for each phase may be determined. A comparison between a current gate strength and the gate strengths determined for the one or more switching events may be made to determine whether the current gate strength requires updating (modifying).

A determination may be made as to whether a gate strength control signal or other control signal may be updated in time to affect a modification to the gate strength. For example, in order to change (modify) the gate strength for a first switching event, the control signal may need to be updated. A first time associated with a time to generate the control signal may be determined. A second time associated with a time to apply the control signal may be determined. The first time and the second time may be considered when determining whether a control signal may be modified to affect a gate strength change for a switching event (e.g., the first switching event).

For example, in FIG. 5A, currents may be sampled to determine one or more switching events (predicted current locations). Switching events may be found, for example, near t=0.5 T, 1.5 T, and 2.5 T. The one or more switching events may be an on-time or an off-time. The switching event at t=0.5 T may be determined to not be a switching event where the gate strength may be adjusted, since the switching event at t−0.5 T occurred during the process of determining one or more switching events (e.g., the one or more algorithms did not have enough time to complete their calculations). A predicted current may be determined for each of the switching events. Because the insufficient time available to change the gate strength due to the lockout timing, the logic in FIG. 5B may be used.

A determination may be made that a gate control signal may be successfully modified and applied at the switch driver in order to affect a modification (change) to the gate strength before a lockout time. The lockout time may be, for example, an amount of time left before switching event near t=1.5 T that may include time to change the switch driver strength before the lockout time. Accordingly, the gate control may be modified and sent to the switch driver. In FIG. 5A, for example, an on-time update to a timer module may be applied just prior to or just after T.

In some instances, gate strengths may be dynamically determined at the start of a PWM calculation window, t=0. Phase currents may be sampled and calculations may be made for their control. One or more switching events for one or more future PWM periods may be determined. For example, on-times and/or off-times for a next PWM update to the devices may be calculated.

Once the on-times for the next period are known, the current at the one or more switching events (locations) may be estimated from a current observer using the last measured current and the commanded voltage. Based on the predicted currents and DC voltage, the appropriate gate strength for each switching event of each PWM period for each phase is determined. An on-time gate strength change may update a timer module. The on-time gate strength change updating a timer module may be applied just prior to T or 1.5*T.

Determining a time to apply a gate strength modification may be made for each switching event for each PWM period for each phase. For Case 1 situations, for a given phase, when a next switching event occurs near the middle of a next period (e.g., 1.25 T to 2 T), a gate strength may be written out at t=T, provided the lockout time of the timer module and the switch driver may be guaranteed. This may ensure that the gate strength is not changed prematurely, impacting a switching event in a present period.

FIG. 5B may depict an exemplary plot 550 of an upper switch gate signal and a lower switch gate signal with a switching event near a start of a sampling period, according to one or more embodiments. FIG. 5B illustrates upper gate signal 505 and lower gate signal 510, as described above in the description of FIG. 5A. FIG. 5B may be considered a Case 2 situation.

FIG. 5B may depict a timing diagram from a standard center-based SVM algorithm for one phase. Upper gate signal 505 and lower gate signal 510 are shown relative to the current sample location (0, T, nT), on-time calculations, locations where predicted current is needed and where the gate strength needs to be updated.

As described above in the description of FIG. 5A, currents may be sampled and on-times (one or more switching events) may be determined for a first (next) PWM period (T to T2) and a gate strength may be determined. A time to apply the gate strength may be determined based on a lockout time at the end of the first PWM period. A similar determination may be made for a second PWM period (T2 to T3).

For Case 2, when the switching event occurs near the very start of a period (e.g., t=T), there may be two options to consider. For cases where the algorithm completes before a switching driver lockout window of the present period's switching event, the gate strength may be updated. This may occur for cases of low switching frequencies. A second option may be available when a switching event, located before time T and right after time T, will be in a lockout window. Such cases may require updating the gate strength for the period in the 1.75 T to 2.25 T range. The updated gate strength may be applied after the switching event near time T (e.g., at 1.5*T).

When the switching event needs full voltage, the on-times may range from 0 to 100%. Therefore, transitions between Case 1 and 2 (and Case 2 to 1) may need to be considered. In addition, for duty cycles between Case 1 and 2, there may be the potential to update on two edges instead of one, provided that the various lockout times associated with the switching event may be satisfied. When the switching frequency becomes too high and the various update times may not be met, the gate strength update (modification) may be pushed to subsequent periods or a modified RMS-based algorithm may be used.

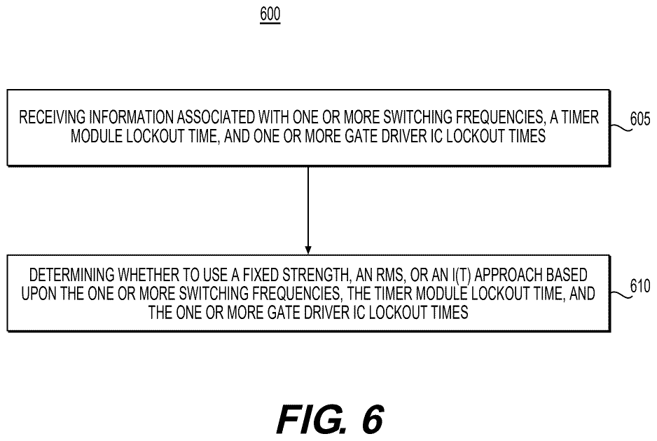

FIG. 6 depicts an exemplary flow chart of a method 600 for dynamically determining a control method. The method 600 may be associated with determining a gate strength for one or more upper phase switches 244 or lower phase switches 248 of power converter 100 as described above in FIG. 2. Controller 300 (or other controller) may implement the following operations of method 600.

At operation 605, method 600 may include receiving information associated with one or more switching frequencies, a timer module lockout time, and one or more switch driver integrated circuit (IC) lockout times. Controller 300 (or other controller) may receive the information. The information associated with one or more switching frequencies may include switching frequencies related to one or more switch drivers associated with upper phase switches 244 or lower phase switches 248 of power converter 100. Information associated with the timer module lockout time may include timing associated with hardware requirements, timer update delays, or the like.

At Operation 610, the method 600 may include determining whether to use a fixed strength approach, a modified RMS approach, or an I(t) approach based on the one or more switching frequencies, the timer module lockout time, and the one or more switch driver IC lockout times. Controller 300 (or other controller) may determine to use a fixed strength (FS) approach, a modified RMS approach, or an I(t) approach based on a timing requirement. The timing requirement may be associated with the one or more switching frequencies, the timer module lockout time, and the one or more switch driver IC lockout times.

For example, a fixed strength approach to determining a gate strength of a switching device associated with power converter 100 (e.g., a switch driver) may require a first time associated with determining and/or implementing a gate strength. A modified RMS approach to determining a gate strength of the switching device may require a second time associated with determining and/or implementing a gate strength. An instantaneous current (I (t)) approach to determining the gate strength of the switching device may require a third timing requirement associated with determining and/or implementing a gate strength. The first timing requirement may be less than the second timing requirement. The third timing requirement may be greater than the second timing requirement. The third timing requirement may be greater than the first timing requirement. In some instances, controller 300 may determine to use the I(t) approach based on a determination that an available time exists to implement the I(t) approach, thereby decreasing switching losses.

In some instances, determining which approach to use to determine a gate strength may include determining a switching frequency. For example, for sufficiently low switching frequencies, the one or more lockout times may be satisfied provided an update may be accomplished before T+Lockout Time(s) in the next period. In this case, the I(t) approach may be utilized. If the update cannot be accomplished in time, the RMS approach may be used. Additionally, currents may be predicted over longer periods of time (e.g., over 5 T, 6 T or longer) considering the associated risk/uncertainty. A fixed strength approach may be considered for instances involving faults, concerns with being able to dynamically respond to current command changes, and other matters.

The first timing requirement, the second timing requirement and the third timing requirement may be based on an available time to change (modify, generate) a gate control signal for a future switching event. Determining an available time to change a gate control signal for a future switching event may include information associated with the one or more switching frequencies, the timer module lockout time, and the one or more switch driver IC lockout times. The first timing requirement, the second timing requirement and the third timing requirement may be based on a determination of an available time to calculate a change to a gate control signal for a future switching event. Determining an available time to calculate a change a gate control signal for a future switching event may include information associated with the one or more switching frequencies, the timer module lockout time, the one or more switch driver IC lockout times, processing time at one or more devices, processing times at one or more controllers, algorithm computing time, and other calculating parameters.

The determination of an approach to determine a gate strength may include one or more additional parameters, such as an expected efficiency related to using one or more approaches, processing capacity of one or more devices, and other parameters related to determining gate strength and updating gate strength at a switch driver (e.g., gate driver). For example, requirements associated with one or more hardware pins may be considered if the gate strength is transmitted via discrete output signals. This may produce a need for multiple pins to change concurrently. In other instances, sufficient hysteresis on one or more current transition points may be a further parameter considered in determining the one or more approaches, as hysteresis increases switching losses. Considering the hysteresis component may ensure that too strong of a gate strength is not used.

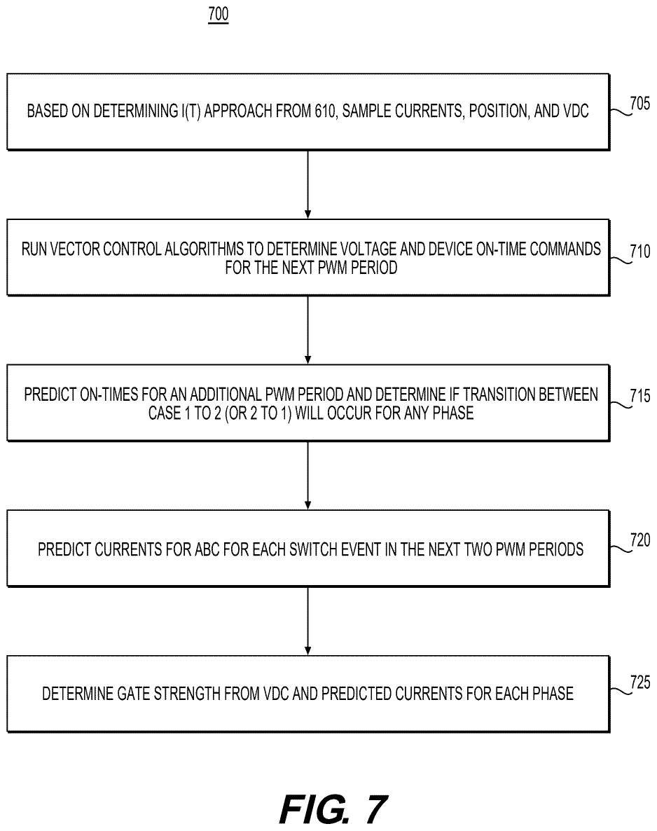

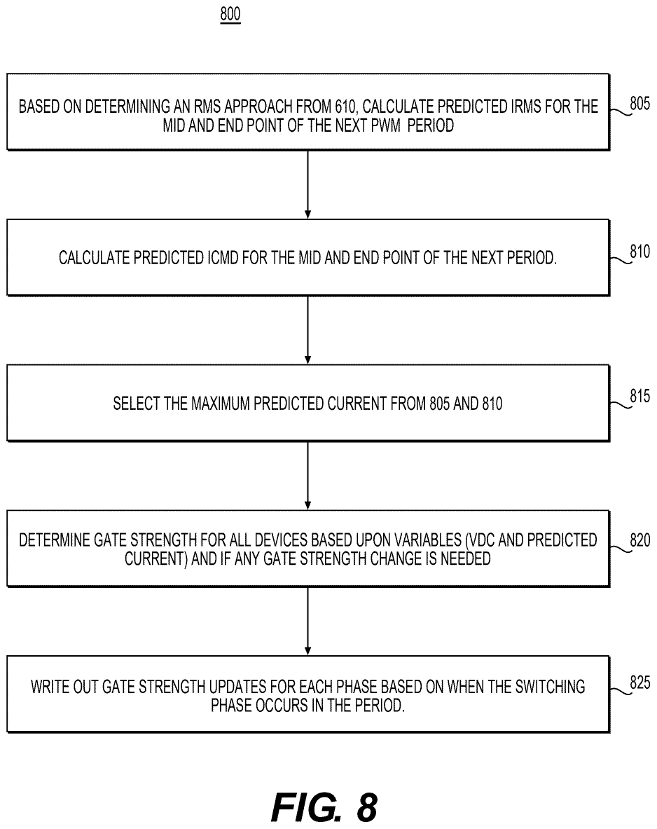

A fixed strength approach (FS method) to determining a gate strength may include determining the gate strength based on a fixed current. A modified RMS approach (RMS method) may include determining the gate strength based on an RMS current for each of the three phases of power converter 100, then using a lookup table, such as Table 1 above, to determine a gate strength. The modified RMS approach may ensure that when the RMS approach is employed, each gate strength per phase is correctly changed. The weakest gate strength may be chosen to ensure operating the switch driver and the switches safely. The modified RMS approach may further include determining a gate strength for each phase of power converter 100, as described below in the description for FIG. 8. The I(t) approach (IC method) may further include determining the gate strength based on an instantaneous current measurement. The modified RMS approach may control when the update to the gate strength is made (written out) to ensure avoiding applying too strong a gate strength on a given phase during a strength transition. The I(t) approach is further disclosed below in the description for FIG. 7.

FIG. 7 depicts an exemplary flow chart of a method 700 for determining a gate strength based on an instantaneous current “I(t)”. Controller 300 (or other controller), as described above in the description of FIG. 3, may implement the following operations of method 700.

The I(t) approach may include a sophisticated algorithm employed that considers a PWM technique and switch driver timing requirements. The algorithm may include a Nearest 2 Vector Space Vector Modulated strategy (N2V SVM). By considering the PWM techniques and the switch driver timing requirements, the I(t) approach may further reduce inverter losses.

At Operation 705, method 700 may include based on determining to employ an I(t) approach from Operation 610, sample currents, position, and the DC voltage. Sampling the currents may include an instantaneous current measurement. The position may be the machine's (rotor's) angular position. For example, the rotor position and the torque (current commands) may determine a frequency and a phase of the A, B. C currents. The phase current, position, and current commands may determine a required phase voltage, one or more switching events, and the locations where the current samples need to be predicted.

At Operation 710, method 700 may include running one or more vector control algorithms to determine voltage and device on-time commands for the next period. The on-time commands may be one or more switching events. Controller 300 (or other controller) may calculate one or more switching events for a next PWM period (e.g., a first PWM period). The one or more switching events may include a first switching event and second switching event.

At Operation 715, method 700 may include predicting on-times for an additional PWM period and determining whether transition between Case 1 to 2 (or 2 to 1) will occur for any phase of power converter 100. Controller 300 (or other controller) may calculate one or more switching events for the additional period (e.g., a second PWM period, T2 to T3 in FIG. 5A and FIG. 5B). The one or more switching events of the second PWM period may include a third switching event and a fourth switching event.

Controller 300 (or other controller or processor) may determine whether the first PWM period and the second PWM include a switching event near a middle of a sampling period (Case 1), as described above in the description of FIG. 5A. Controller 300 (or other controller or processor) may determine whether the first PWM period and the second PWM include a switching event near a start of a sampling period (Case 2), as described above in the description of FIG. 5B. Controller 300 (or other controller or processor) may determine whether the first PWM period and the second PWM include a transition from Case 1 to Case 2. Controller 300 (or other controller or processor) may determine whether the first PWM period and the second PWM include a transition from Case 2 to Case 1.

At Operation 720, method 700 may include predicting currents for each power converter phase (A, B, C) of power converter 100 for each switching event in the next two PWM periods. Controller 300 (or other controller or processor) may employ one or more algorithms, such as those described above, to predict current for each phase of power converter 100 (e.g., A, B, C). The predicted currents may be based on the controller voltage commands (which may set one or more on-times), one or more machine parameters, and one or more instantaneous current measurements. The predicted currents may also be based on the existing current and a rotor position.

For example, predicting currents for each phase of the power converter may include determining a first estimated current based on the first switching event, determining a second estimated current based on the second switching event, determining a third estimated current based on the third switching event, and determining a fourth estimated current based on the fourth switching event.

At Operation 725, method 700 may include determining a gate strength from Vdc and the predicted currents for each phase of power converter 100. Controller 300 (or other controller or processor) may employ one or more algorithms, such as those described above, to determine a gate strength for each phase of power converter 100 (e.g., A, B, C, as described in FIG. 2). The gate strength may be based on predicted currents from Operation 720, the DC voltage, or other parameters. Controller 300 (or other controller) may determine to update a current gate strength based on the determined gate strength (updated gate strength). Controller 300 (or other controller) may generate a control signal to control the switch driver based on the gate strength for the switch driver. Controller 300 (or other controller) may generate a control signal to control the switch driver based on a determined time. The determined time may be associated with when a control signal may update a current gate strength of the switch driver with the updated gate strength.

Determining an updated gate strength may include determining a first estimated gate strength based on the first estimated current. Determining an updated gate strength may include determining a second estimated gate strength based on the second estimated current. Determining an updated gate strength may include determining a third estimated gate strength based on the third estimated current. Determining an updated gate strength may include determining a fourth estimated gate strength based on the fourth estimated current.

Determining an updated gate strength may be based on whether the first PWM period and the second PWM period are located in Case 1, Case 2, a transition from Case 1 to Case 2, or a transition from Case 2 to Case 1. When the first PWM period and the second PWM period are located in Case 1, the updated gate strength may be determined based on the weakest gate strength from the first estimated gate strength and the second estimated gate strength. When the first PWM period and the second PWM period are located in Case 2, the updated gate strength may be determined based on the weakest gate strength from the second estimated gate strength and the third estimated gate strength.

When the first PWM period and the second PWM period are located in a transition from Case 1 to Case 2, the updated gate strength may be determined based on the weakest gate strength from the first estimated gate strength, the second estimated gate strength, and the third estimated gate strength. When the first PWM period and the second PWM period are located in a transition from Case 2 to Case 1, the updated gate strength may be determined based on the second estimated gate strength.

FIG. 8 depicts an exemplary flow chart of a method 800 for determining a gate strength based on a modified root mean square (RMS) current. Controller 300 (or other controller), as described above in the description of FIG. 3, may implement the following operations of method 800.

At Operation 805, method 800 may include, based on determining a modified RMS approach from Operation 610, calculating a predicted Irms (RMS current) from a current observer on the measured current for a midpoint and an endpoint of a next period. Controller 300 may receive the predicted Irms. Controller 300 may determine (calculate) the predicted Irms.

At Operation 810, method 800 may include calculating a predicted Icmd (predicted current) for a midpoint and an endpoint of a next period. Controller 300 may receive the predicted Icmd for the midpoint and the endpoint of the next period. Controller 300 may determine (calculate) the predicted Icmd for the midpoint and the endpoint of the next period.

At Operation 815, method 800 may include selecting a maximum predicted current from Operation 805 and Operation 810. For example, controller 300 may compare the above predicted Irms and Icmd currents from the operations above and determine to use the maximum current.

At Operation 820, method 800 may include determining a gate strength based upon variables (Vdc and predicted current) and if any gate strength change is needed. The predicted current may be the current determined in Operation 815. Controller 300 may determine whether the determined gate strength is already applied at the switch driver. When controller 300 determines that the determined gate strength is already applied at the switch driver, controller 300 may end the method. For example, controller 300 may determine that the next gate strength needed is a medium strength. Controller 300 may determine that the switch driver is already operating at a medium strength. In these cases, controller 300 may end method 800, or controller 300 may determine to return to operation 805 or 605.

At Operation 825, method 800 may include writing out gate strength updates for each phase based on when one or more switching events occur in one or more PWM periods. After determining that a gate strength change is needed, controller 300 may write out gate strength updates for each phase of power converter 100 requiring a gate strength update. Each phase of power converter 100 may require a different gate strength. Each phase of power converter 100 may require the same gate strength. Controller 300 may determine a time to update the gate strength for each A, B, C phase based on when the one or more switching events occur in the one or more PWM periods. For example, if a switching event for a phase (A, B, or C) occurs at the end of a PWM period, controller 300 may determine to update the gate strength for that phase at the beginning of the PWM period. Controller 300 may take into consideration one or more timing requirements of the system, as described above, when determining a time to update the gate strength.

One or more embodiments may interleave each phases' current prediction and the corresponding gate strength updates with a PWM strategy to ensure the gates have the correct drive strength during a switching event. Due to a switch driver timing requirement, the gate strength may not be commanded by relatively low bandwidth communication pathways such as SPI. Even discrete I/O pins may consider a switch driver's internal timing requirement which may include a lockout window before a switching event.

One or more embodiments may dynamically determine a gate strength for one or more PWM periods. Based on the predicted currents and DC voltage, the appropriate gate strength for each switching event within each PWM period for each phase of a converter may be determined.

One or more embodiments may dynamically determine when to apply (write out) a gate strength, thereby preventing impacting a switching event in the present period. For cases where the algorithm completes before the gate drive lockout window of the present period's switching event, the gate strength may be updated. This may occur for cases of low switching frequencies. When the switching event occurs before time T and right after time T, the switching event may be a lockout window. In such cases, the gate strength update (modification) may need to be determined for the period in the 1.75 T to 2.25 T range. The gate strength update may be applied after the switching event near time T. The update would naturally be made at the time 1.5*T. This may ensure that the gate strength is not changed prematurely thereby impacting a switching event in the present period.

One or more embodiments may consider updating gate strengths for transitions between Case 1 and 2 and transitions between Case 2 and Case 1. In addition, for duty cycles between Case 1 and 2, there may be potential to update on two edges instead of one, provided that the various lockout times may be satisfied. When the switching frequency becomes too high and the various update times cannot be met, the gate strength update may be pushed to subsequent PWM periods or an RMS-based algorithm can be used.

One or more embodiments may modify to the simplified RMS strategy, thereby addressing the problem of switching loss due to a hysteresis window. Using the one or more embodiments with the simplified RMS strategy (the modified RMS approach) may improve the switching efficiency of one or more devices.

One or more embodiments may determine whether to use a fixed strength (weakest) approach, a modified RMS approach, or an I(t) approach to dynamically determine gate strength. Determining whether to use the fixed strength (FS) approach, the RMS current approach, or the I(t) current approach may be based upon switching frequency, timer module lockout time, one or more switch driver IC lockout times, and other time related factors.

One or more embodiments may use an instantaneous current I(t) approach for dynamically determining gate strength. For example, sample currents, positions and Vdc may be determined. One or more vector control algorithms may be used to determine phase voltage commands and device on-time commands for the next period. On-times for an additional period may be determining and analyzed to determine whether a transition between Case 1 to 2 (or 2 to 1) will occur for any PWM period. Currents may be predicted for each phase (A, B, C) for each switching event in the next two PWM periods. Gate strengths may be determined from Vdc and predicted currents for each switching event of each PWM period for each phase (A, B, C).

One or more embodiments may identify whether the next two PWM periods are located in a Case 1 situation, a Case 2 situation, a Case 1 to a Case 2 transition, or a Case 2 to a Case 1 transition. For Case 1 situations, predicted currents from the next period may be used to determine gate strength. Of these gate strengths, the weakest strength is selected and commanded at end of PWM period. For Case 2 situations, predicted currents for next period's last switching event and a subsequent period's first switching event may be used to determine a gate strength. However, using only a last period's switching event may be an allowable simplification. The weakest strength is selected and commanded at end of a PWM period. For Case 1 to Case 2 transitions, predicted currents for the next period's two events and a subsequent period's first event may be used to determine a gate strength. The weakest gate strength may be selected and commanded at end of a PWM period. For Case 2 to Case 1 transitions, predicted currents for next period's last event may be used to find gate strength. The gate strength may be commanded at end of a PWM period.

One or more embodiments may use a modified Irms (RMS current) approach to dynamically determine a gate strength. Predicted Irms may be determined from a current observer on the measured current for the midpoint and endpoint of a next PWM period. A predicted Icmd may be determined for the midpoint and the endpoint of the next PWM period. A maximum predicted current from the predicted Irms and predicted Icmds may be determined. Gate strengths may be determined for all devices based upon variables Vdc and predicted currents. A determination may be made regarding whether any gate strength change is needed. When determining a gate strength change is needed, and determining that switching events occur near the middle of the next PWM period, gate strength updates may be written out at the end of the present PWM period. When switching events occur near the start of the next period, commands may be written out at the end of a present PWM period or after the middle of a next PWM period.

One or more embodiments may determine whether the switching rate is a low switching rate. When determining that the switching rate is a low switching rate, sufficient time may be provided to finish all algorithms and update the gate strength by the midpoint of the present period. Update times may be moved to either a present PWM period midpoint or a present PWM period end point.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method comprising:
determining a control method, among each of a fixed strength (FS) method, a root mean square current (RMS) method, and an instantaneous current (IC) method, for a switch driver of a power converter, based on a switching frequency, a time module lockout time, and a switch driver lockout time; and
generating a control signal for the switch driver based on the determined control method.

2. The method of claim 1, wherein the determining the control method includes determining the control method as the FS method based on a first timing requirement.

3. The method of claim 2, wherein the determining the control method includes determining the control method as the RMS method based on a second timing requirement,
wherein the second timing requirement is greater than the first timing requirement.

4. The method of claim 3, wherein the determining the control method includes determining the control method as the IC method based on a third timing requirement,
wherein the second timing requirement is greater than the first timing requirement, and
wherein the third timing requirement is greater than the second timing requirement and the first timing requirement.

5. The method of claim 1, wherein the FS method includes:
generating a gate strength based on a peak current and a DC-link voltage to control a first phase, a second phase, and a third phase of the power converter.

6. The method of claim 1, wherein the RMS method includes:
generating a gate strength for the switch driver of the power converter based on an RMS current of a phase of the power converter.

7. The method of claim 1, wherein the IC method includes:
generating a gate strength for the switch driver of the power converter based on an instantaneous current of a power converter phase; and
generating the control signal to control the switch driver based on the gate strength for the switch driver.

8. The method of claim 1, wherein the switch driver is provided in the power converter of an electric vehicle.

9. A method comprising:
determining a first switching event for a first pulse width modulation (PWM) period based on an instantaneous current, a voltage, and a position in a PWM sequence;
determining a first estimated current based on the first switching event;
generating a first estimated gate strength for the first switching event based on the first estimated current;
generating an updated gate strength based on the first estimated current;
determining a time to modify a switch driver with the updated gate strength; and
generating a control signal based on the determined time, wherein the control signal updates a current gate strength of the switch driver with the updated gate strength.

10. The method of claim 9, further comprising:
determining a second switching event for the first PWM period;
determining a third switching event and a fourth switching event for a second PWM period; and
generating the updated gate strength based on the second switching event, the third switching event, and the fourth switching event.

11. The method of claim 10, wherein determining the updated gate strength includes:
determining a second estimated current based on the second switching event;
determining a third estimated current based on the third switching event; and
determining a fourth estimated current based on the fourth switching event.

12. The method of claim 11, wherein the generating the updated gate strength further includes:
generating a second estimated gate strength based on the second estimated current;
generating a third estimated gate strength based on the third estimated current; and
generating a fourth estimated gate strength based on the fourth estimated current.

13. The method of claim 12, wherein the generating the updated gate strength further includes:
generating the updated gate strength based on a weakest gate strength from the first estimated gate strength and the second estimated gate strength.

14. The method of claim 12, wherein the generating the updated gate strength further includes:
generating the updated gate strength based on a weakest gate strength from the second estimated gate strength, and the third estimated gate strength.

15. The method of claim 12, wherein the generating the updated gate strength further includes:
generating the updated gate strength based on a weakest gate strength from the first estimated gate strength, the second estimated gate strength, and the third estimated gate strength.

16. The method of claim 12, wherein the generating the updated gate strength further includes:
generating the updated gate strength based on the second estimated gate strength.

17. A method comprising:
determining an RMS current based on a first PWM period;
determining a predicted current based on the first PWM period;
generating a gate strength based on the RMS current and the predicted current;
determining a time to modify the gate strength; and
generating a control signal to modify the gate strength of a first phase based on the determined time.

18. The method of claim 17, wherein determining the RMS current based on the first PWM period includes:
determining a measured current for a midpoint and an endpoint of the first PWM period.

19. The method of claim 18, wherein determining the predicted current based on the RMS current includes:
determining the predicted current based on the midpoint and the endpoint of the first PWM period.

20. The method of claim 19, wherein the generating the gate strength includes:
determining a maximum current from the RMS current and the predicted current.
